(19) United States
(12) Patent Application Publication
(10) Pub. No.: US 2009/0233078 A1
(43) Pub. Date: Sep. 17, 2009

(54) Intercrystaline coloration methods in marbles, granites, limestone and stones in general and products thereof

(75) Inventor: Pedro Carmo Deccache Neto, Rio de Janeiro (BR)

Correspondence Address: THE NATH LAW GROUP, 112 South West Street, Alexandria, VA, 22314, US

(73) Assignee: STONE PRESTACAO DE SERVICOS LTDA, Rio de Janeiro (BR)

(21) Appl. No.: 12/453,809

(22) Filed: May 22, 2009

Related U.S. Application Data
(62) Division of application No. 11/585,776, filed on Oct. 25, 2006.

(30) Foreign Application Priority Data
Aug. 22, 2006 (BR) PI0603397-0

(51) Int. Cl. B32B 3/26

(52) U.S. Cl. 428/304.4

(57) ABSTRACT

The present invention relates to intercrystaline coloration methods in marbles, granites, limestones and stones in general, and to products thereof, wherein after the colorants (3) application on the stone slabs surface, such stone slab surface (2) are submitted to vacuum or pressure for the obtainment of the coloration resultant from one or several colors applied simultaneously in said stone slab (2).

### FIELD OF THE INVENTION

The present invention relates to intercrystaline coloration methods in marbles, granites, limestone and stones in general, aimed to modify or add colors to plate and parts of marbles, granites, limestone and stones in general in order to obtain a new visual effect in the stone slab submitted to said method.

### BACKGROUND OF THE INVENTION

The stones, specially marbles, granites and limestones, are very used a long time ago as building elements, more specifically as coverage, and also as ornamental purpose. However, such stones have a relatively predicable visual aspect, and thus they are known according to the type of stone and from where it cames.

In order to provide a different visual aspect to the stone slabs and increase the choice of colors, some methods to obtain different colors for the marbles, granites and limestones in general are known, different from the colors that are usually found in nature.

A known method consists in pre-heating a stone slab which is desired to be submitted to the coloration process, it being then immersed in a bath containing a colorant substance which is made circle throughout the whole surface or a part of said slab stone. Afterwards, it is removed from said coloring bath in order to drain the excess of coloring substance and then, submitted to wash.

This coloration by immersion method is ineffective and further has the disadvantage of usually needing a recipent of large dimensions for immerging the stone slab, what also demands the use of great amounts of colorants. Another disadvantage of this method is to allow the employment of just one single color for each immersion bath, what limits the effects caused by the coloration that is desired to be printed to the stone slab.

Furthermore, it was proved, after countless tests, that the immersion of the finished piece or crude plate is not effective in relation to the total absorption of the stone in its thickness, since after an infinity of tests for several years, it was evidenced that independent from the amount of the used colorant liquid or from the depth of the immersion of the slab or the position of the slabs to the coloration, in vertical or horizontal tanks and even independent from the time that the stone remains submerged, it still presents fail with a colorless line localized in the symmetric center of its thickness, since the coloration does not occur in order to total and uniformly color the thickness of the stone, to make possible post work and completion.

What was verified and proved is that in the immersion, the colorant liquid even after 15 days covering the slab, independent from the amount of liquid or depth of the slab, after the liquid enter by the upper part of the stone and by the lower part, an air cushion is formed in the middle avoiding the colorant liquid to penetrate in the hole thickness of said slab-stone, in other words, a side harms the penetration of the other, forming a colorless line in the middle, as a consequence of the expulsion of the pores air that is not reached since it is found paint obstructing the passage of the air from out of the other side.

Therefore, it is an objective of the present invention the provision of methods developed to allow the total absorption by the slabs in its thickness, reaching the aimed and desired total coloration, eliminating all the restrictions for the industrialization and improvement process.

Another objective is the production of a plate or a slab having several colors in different areas, in other words, multicolor slabs.

### SUMMARY OF THE INVENTION

In order to overcome the inconveniences of the immersion method described previously, it were developed the coloration methods, which are subject matter of the present invention.

In a first embodiment of the present invention, the stone slab receives on its surface submitted to the coloration method, a colorant solution, afterwards the stone slab is placed in a stuffiness chamber, then being submitted to a stuffiness method. Thus, the colorant penetrates by the surface of the stone slab.

In an alternative embodiment of the present invention, after the employment of a coloring solution in a surface of the stone slab, said colorant solution is forced to cross all the thickness of the stone slab through the use of air negative pressure exercised in the opposite surface of the stone slab in which the colorant solution was applied. By this way the colorant substance is absorbed by the pores of the stone slab totally.

In another embodiment of the present invention, after the colorant solution be applied in one or more surfaces of the stone slab, said stone slab is placed in a pressure chamber, said pressure chamber being submitted to a positive pressure of air, in order to make the colorant solution pass throughout the thickness of the stone slab.

In the embodiments described above, it is possible to apply several and different colors in different areas of the stone slab, in order to allow a varied coloration in different areas of the surface of said stone slab, for the production of multicolor slabs and plates, what would not be possible by the immersion of the stone slab in a bath containing a single colorant solution.

The methods described in the embodiments above mentioned can be combined, in other words, it is possible, for instance, firstly submit the stone slab to a coloration method by stuffiness, afterwards to an air negative pressure method and finally to a method of positive pressure of air. Naturally the sequence of said methods will influence the final result obtained in the coloration of said stone slab, what allows the free choice of the sequence to be adopted.

In anyone of the above-mentioned methods and their combinations, it is possible the adoption of countless pluralities of colors and colorant types, such as phosphorescent, reflective, luminescent, fluorescent, etc.

The coloration methods described above can be applied in stone slabs in crude state and without finishing, as well as in stone slabs worked in crude plates, polished or not, since the coloration is total. In other words, the methods can be applied in several types of marbles, granites and stones in general.

### BRIEF DESCRIPTION OF THE DRAWINGS

Another objectives, characteristics and advantages of the present invention will become more evident from the following detailed description, when taken together with the drawings, in which:

FIG. 1a shows a stone slab colored by known immersion methods;

FIG. 1b shows a stone slab colored by the methods of the present invention;

FIG. 2 shows a stone slab placed into a stuffiness chamber;

FIG. 3 shows a stone slab placed into a vacuum chamber;

FIG. 4 shows a stone slab placed into a pressure chamber.

### DETAILED DESCRIPTION OF THE INVENTION

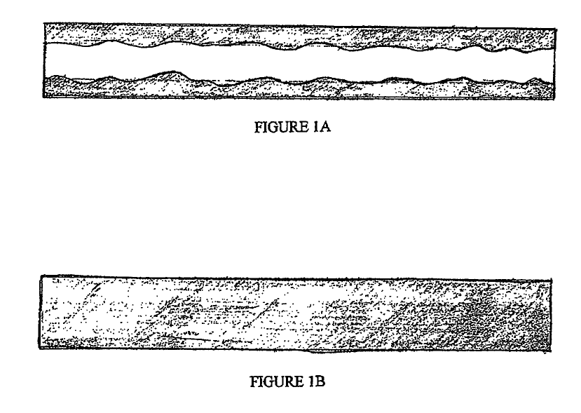

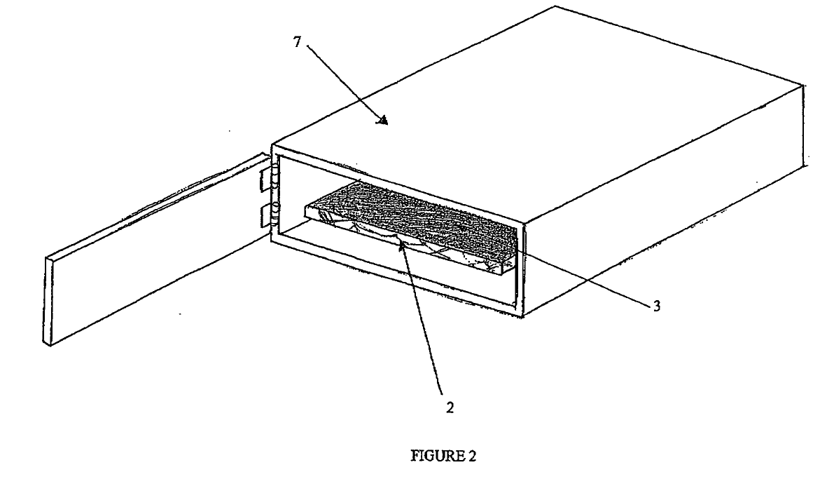

As can be understood from the drawings, wherein equal numeric references identify correspondent parts, FIG. 1a shows a slab colored by immersion method, being possible to observe the non-homogeneous dyeing of the hole thickness of the -stone slab 2, the FIG. 1b shows a stone slab 2 colored by the coloration methods described in the present invention, occurring a homogeneous coloration of the hole thickness of the stone slab 2. FIG. 2 shows a stone slab 2, placed in a stuffiness chamber 7, being applied a coloring solution 3 through the use of brushes, rolls, spray, etc., in one or more surfaces of said stone slab 2, such coloring solution 2 can have different colors for each application area in the stone slab 2. The stuffiness chamber 7 is closed and the stone slab 2 is maintained into the stuffiness chamber 7 by a period of time necessary for the penetration of the colorant solution 3 by the pores of the surface of said stone slab 2, in its hole thickness. The atmosphere inside the stuffiness chamber 7 becomes saturated of colorant solution 3, thus allowing a greater penetration of the colorant solution 3 in the stone slab 2. The stuffiness chamber 7, or the -stone slab 2, can be submitted to heating in order to accelerate the method of total coloration of the stone slab 2.

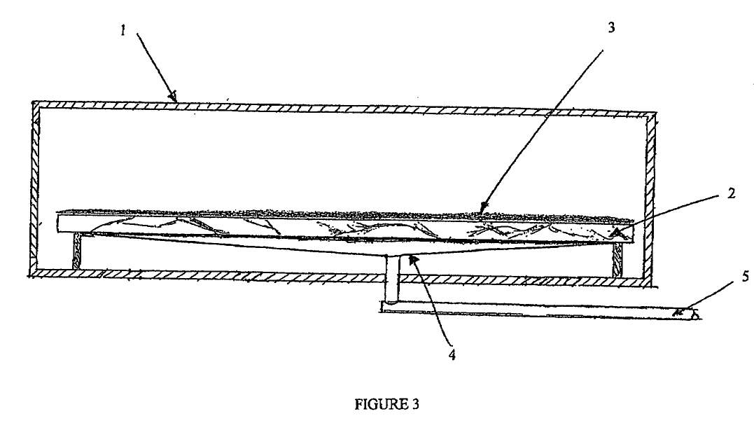

FIG. 3 has a vacuum chamber 1, showed in a longitudinal view, in order to facilitate the viewing of the stone slab 2. After the stone slab 2 be placed into the vacuum chamber 1, the coloring solution 3 is applied using brushes, rolls, spray, etc., in one or more surfaces of said stone slab 2, such coloring solution 3 can be all of a single color or have different colors for each application area of the stone slab 2. Then, the vacuum chamber 1 is closed and the extraction process of the air of its interior is started, trough the mouthpiece 4, that is connected to a piping 5 connected to a vacuum pump (not showed). The mouthpiece 4 is coupled in a tight way to the stone slab 2, so that the air removed from the interior of the vacuum chamber 1 will be forced to pass by the pores of the stone slab 2, thus carrying the colorant solution 3 that is in contact with the surface of the stone slab 2. In this way the colorant solution will penetrate by the pores of the stone slab 2, allowing the coloration of the interior of the stone slab 2, going from one side to another.

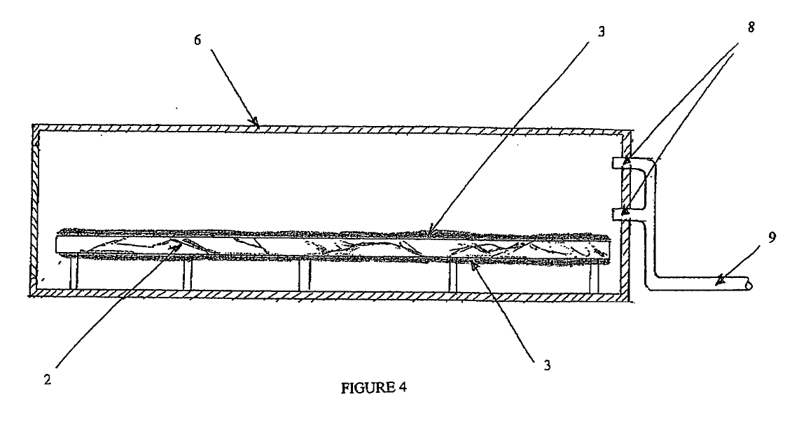

FIG. 4 presents a pressure chamber 6, showed in a longitudinal section view, in order to facilitate the viewing of the stone slab 2. After the stone slab-2 be placed into the pressure chamber 6, a colorant solution 3 is applied using brushes, rolls, spray, etc., in one or more surfaces of said stone slab 2, such coloring solution 3 can be of only one color or have different colors for each application area of the stone slab 2. Then the pressure chamber 6 is closed and the compression process of its interior air is started, through the injection of air trough the mouthpiece 8 which are coupled to a piping 5 connected to an air compressor (not showed). The air pressure increase into the pressure chamber 6 makes the hole surface of said stone slab 2 subjected to the compression and, by this way, the colorant solution 3 that is in contact with the surface of the stone slab 2 is forced to penetrate by the pores of the stone slab 2, allowing the dying of the hole thickness of the slab-stone 2 interior.

The pressure chamber 6, shown in FIG. 3, alternatively can further be used as vacuum chamber, by just connecting the vacuum pump (not showed) to the piping 9, allowing a final result, different of the obtained by the use of the vacuum chamber 1, as described in FIG. 2, to be obtained.

In the above-described methods, the stone slab 2 can be heated in order to accelerate the coloration method. Said coloration methods are complemented by the use of a proofing specially developed, based of vegetable oils that do not attack neither the stone nor the color, mixed to the coloring solution 3 that penetrates in the interior of the stone slab 2, the proofing, by this way, protecting against degrading agents of the stone and protecting the applied color against abrasive products, the natural wear, besides stabilizing and fixing the resulting coloration in the stone slab 2 and making it hydro-oil repellent.

1-17. (canceled)

18. Intercrystaline coloration products in marbles, granites, limestones and stones in general, characterized in that such products are obtained from the method in which a colorant solution (3) is applied on the surfaces of the stone slab (2), characterized in that said stone slab (2) is placed in a stuffiness chamber (7), by a period of time necessary for the penetration of the the colorant solution (3) by the pores of the surface of said stone slab (2), in its hole thickness.
